(19) United States
(12) Patent Application Publication
(10) Pub. No.: US 2008/0308205 A1
(43) Pub. Date: Dec. 18, 2008

(54) TIRE TREAD WITH SYNTHETIC FIBERS

(75) Inventor: Francis J. Byrne, Franklin, TN (US)

Correspondence Address: BRIDGESTONE AMERICAS HOLDING, INC., 1200 FIRESTONE PARKWAY, AKRON, OH, 44317, US

(73) Assignee: Bridgesione Firestone North American Tire, LLC

(21) Appl. No.: 11/764,322

(22) Filed: Jun. 18, 2007

(51) Int. Cl. B60C 11/00; B29D 30/66

(52) U.S. Cl. 152/209.4; 156/114

(57) ABSTRACT

A tire having a circumferential tread is disclosed. In one embodiment, a plurality of synthetic fibers are embedded in the circumferential tread such that a portion of at least one of the plurality of synthetic fibers is exposed to a surface of the circumferential tread, wherein the plurality of synthetic fibers have empty cavities configured to be at least partially filled with a liquid.

### FIELD OF INVENTION

The present application relates to a tire that includes a plurality of fibers embedded in a circumferential tread. More particularly, it relates to a tire with a plurality of synthetic fibers, each fiber having a hollow portion configured to be filled with water and other liquid.

### BACKGROUND

Many motor vehicle tires have a circumferential tread provided with a plurality of spaced-apart circumferential grooves that define ribs therebetween. Typically, generally lateral slots can be provided in the ribs to form a plurality of shaped blocks. These shaped blocks can be distributed along the tread according to a specific pattern. Sipes, which are generally narrow slits cut into the tread, can be provided in the shaped blocks in a specific pattern to improve tire traction in wet, snowy, and icy conditions.

Wet surfaces are known to affect tire performance. As shown in FIG. 1A, the simplified graph 100a illustrates that even slightly damp roads have a significant impact on the performance of a tire. Similarly, when a tire contacts a snowy or icy road, the pressure from the weight of a vehicle melts the snow or ice, thus creating wet conditions.

At one extreme of the phenomena, known as hydroplaning, the tread pattern has a significant impact on the performance of the tire. Grooves, channels, or sipes, improve tire performance in very wet conditions, because as the tire contacts the wet surface, pressure from the weight of the vehicle causes the water (or other liquid) on the surface to be diverted into the voids created by these elements and away from the road surface, enabling the tire to better contact and conform to the surface. At the other end of the scale of wet performance—when the surface of the road is merely damp, the tread pattern is only partially effective in clearing water and other liquids from the surface.

### SUMMARY

In one embodiment of the application, a plurality of synthetic fibers are embedded in a circumferential tread of a tire. During use of the tire, a portion of at least one of the plurality of synthetic fibers is exposed to a surface of the circumferential tread. In other words, at least a portion of the synthetic fibers is not covered by rubber. Each synthetic fiber has a hollow portion configured to be filled with water or liquids. The scope of the invention discussed herein is defined by the claims appended hereto.

### BRIEF DESCRIPTION OF DRAWINGS

In the accompanying drawings, tires and tread patterns are illustrated that, together with the detailed description provided below, describe exemplary embodiments of the claimed invention.

In the following drawings and description, like elements are identified with the same reference numerals. The drawings are not to scale and the proportion of certain elements may be exaggerated for the purpose of illustration.

FIG. 1A illustrates a simplified graph showing prior art tire performance as a function of surface wetness;

FIG. 1B illustrates a simplified graph showing performance of an improved tire as a function of surface wetness;

FIGS. 2A-E are simplified front elevation views of a prior art tire on a dry and wet surfaces;

FIG. 3 is a simplified front elevation view of one embodiment of an improved tire having embedded synthetic fibers on a wet surface;

FIGS. 4A-4C are perspective views of three exemplary embodiments of synthetic fibers for use in an improved tire;

FIG. 5 is a simplified top view of one embodiment of an improved tire tread having embedded synthetic fibers;

FIG. 6 is a simplified top view of an alternative embodiment of a tire tread having embedded synthetic fibers, wherein each fiber is exposed to a surface defining a groove or a sipe;

FIG. 7 is a simplified top view of an alternative embodiment of a tire tread having embedded synthetic fibers, wherein no fibers are exposed to a surface defining a groove or a sipe;

FIG. 8 is a simplified top view of an alternative embodiment of a tire tread having embedded synthetic fibers, wherein the length of each fiber is exposed to the surface;

FIG. 9 is a simplified top view of an alternative embodiment of a tire tread having embedded synthetic fibers, wherein the length of each fiber is exposed to the surface and the fibers are aligned;

FIG. 10 is a simplified top view of an alternative embodiment of a tire tread having embedded synthetic fibers, wherein an end of each fiber is exposed to the surface;

FIG. 11 is a perspective view of a section of one embodiment of a tire tread having embedded synthetic fibers;

FIG. 12 is a simplified top view of one embodiment of a tire tread having embedded synthetic fibers, after a period of use and the fibers have been worn;

FIG. 13 is a flow chart of one embodiment of a method for making a tire having synthetic fibers; and

FIG. 14 is a flow chart of an alternative embodiment of a method for making a tire having synthetic fibers.

### DETAILED DESCRIPTION

The following includes definitions of selected terms employed herein. The definitions include various examples and/or forms of components that fall within the scope of a term. The examples are not intended to be limiting. Both singular and plural forms of terms may be within the definitions.

“Axial” or “axially” refer to a direction that is parallel to the axis of rotation of a tire.

“Circumferential” and “circumferentially” refer to a direction extending along the perimeter of the surface of an annular tread perpendicular to the axial direction.

“Equatorial plane” refers to the plane that is perpendicular to the tire's axis of rotation and passes through the center of the tire's tread.

“Footprint” refers to a surface area covered by a tire in contact with the surface.

“Groove” refers to an elongated void in a tread of a tire that extends circumferentially in a straight, curved, wavy, or zig-zag manner.

“Lateral” or “laterally” refer to a direction along a tread of a tire going from one sidewall of the tire to the other sidewall.

“Radial” or “radially” refer to a direction that is perpendicular to the axis of rotation of a tire.

“Sipe” refers to a thin slit formed in the surface of a tire tread that extends laterally, circumferentially, or at an acute angle with respect to the circumferential direction of the tire. The sipe can be straight, curved, zig-zag, wavy, or take the form of any other non-straight configuration.

“Slot” refers to an elongated void in a tread of a tire that extends laterally or at an angle relative to the circumferential direction of the tire. The slot can be straight, curved, zig-zag, wavy, or take the form of any other non-straight configuration.

“Tread” refers to that portion of a tire that comes into contact with the road under a normal load.

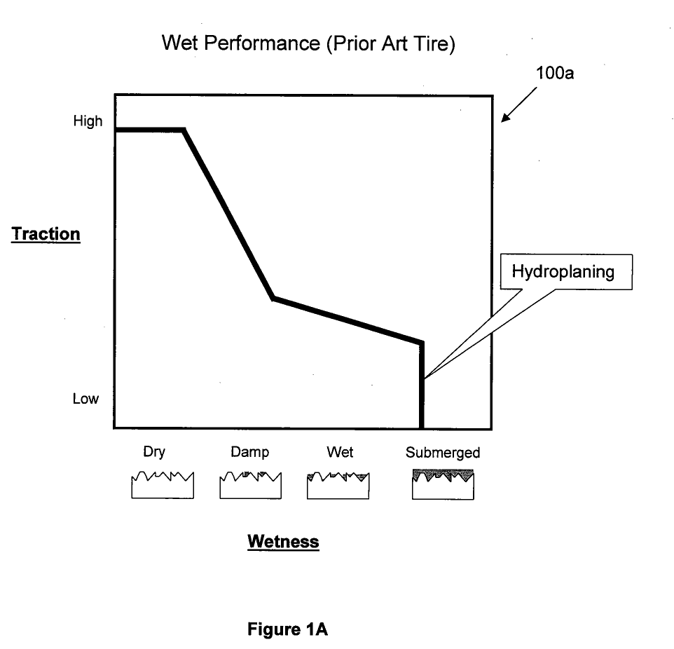

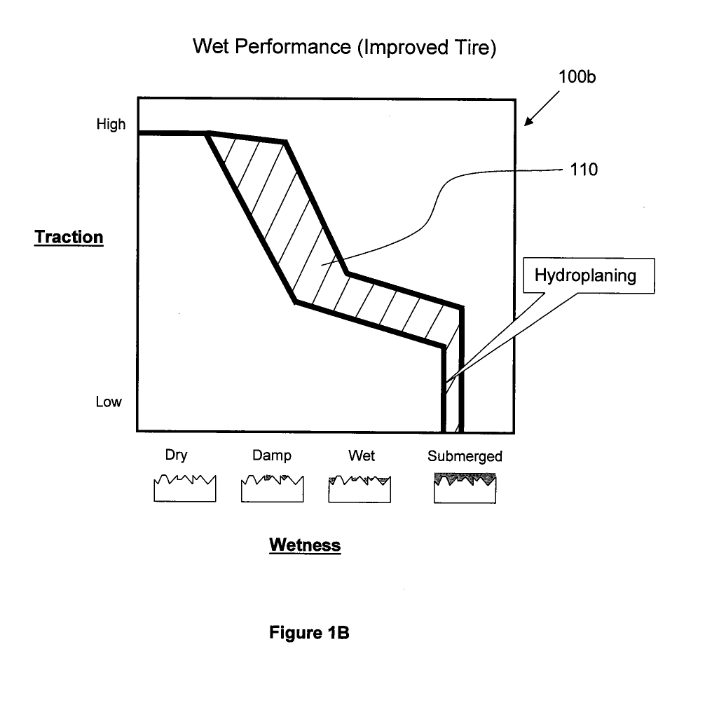

As explained above, FIG. 1A illustrates a simplified graph 10a showing prior art tire performance as a function of surface wetness. FIG. 1B, by comparison, illustrates a simplified graph 100b showing performance of an improved tire as a function of surface wetness.

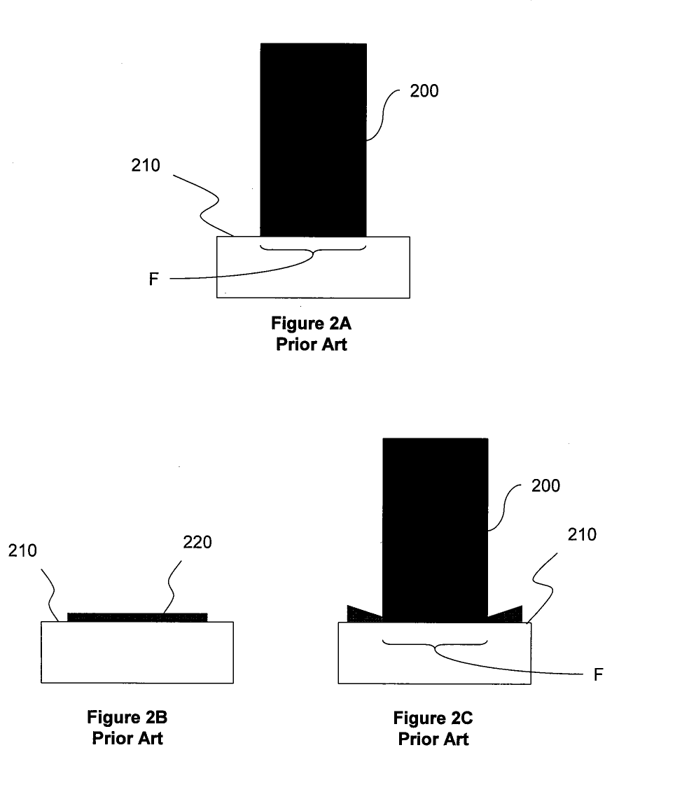

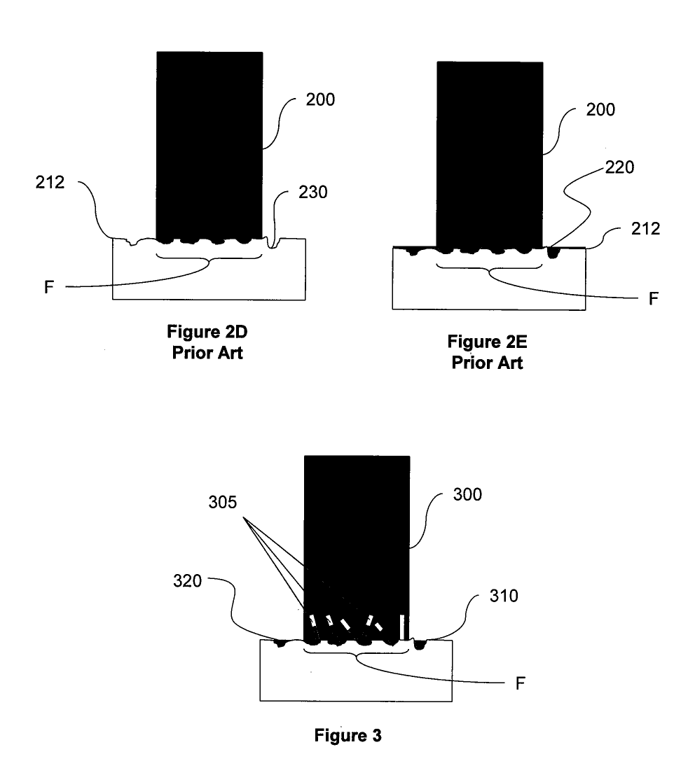

FIG. 2A illustrates a simplified front view of a prior art tire 200 on a flat road surface 210 having no irregularities. When the prior art tire 200 rolls over the road surface 210, the pressure caused by the weight of a vehicle (not shown) causes the tire 200 to conform to the road surface 210 at the footprint F under the tire 200. This contact between the tire 200 and road surface 210 creates traction.

FIG. 2B illustrates a simplified flat road surface 210 having no irregularities, covered with water 220. It should be understood that the road surface 210 may also be covered with oil, chemicals, or any other known liquid.

FIG. 2C illustrates a simplified front view of the prior art tire 200 on a road surface 210 covered with water 220. The prior art tire 200 has grooves, sipes, and/or channels (not shown), that aid in diverting water away from the tire. When the prior art tire 200 rolls over the road surface 210, pressure from the tire 200 forces water 220 into the grooves, sipes, and/or channels, where the water 220 is diverted, allowing the tire 200 to conform to the road surface 210. However, where there is excessive water, the grooves, sipes, and/or channels may not be able to divert all of the water. In this case, water becomes trapped between the tire 200 and the road surface 210, and hydroplaning occurs.

FIG. 2D illustrates a simplified front view of a prior art tire 200 on a road surface 212 having irregularities 230. A typical road surface has irregularities. In the illustrated embodiment, the irregularities 230 of the road surface 212 are enlarged for emphasis. When the prior art tire 200 rolls over the road surface 212, the pressure caused by the weight of a vehicle (not shown) causes the tire 200 to conform to the road surface 212 at the footprint F under the tire 200.

FIG. 2E illustrates a simplified front view of the prior art tire 200 on a road surface 212 having irregularities 230 covered with water 220. It should be understood that the road surface 212 may also be covered with oil, chemicals, or any other known liquid. Irregularities 230 of the road surface 212 causes water or other liquids to collect in puddles or “micro-puddles” as shown. When the prior art tire 200 rolls over the road surface 212, the water 220 is trapped between the tire 200 and irregularities 230 in the road surface 212 at the footprint F under the tire 200, preventing the tire 200 from conforming to the road surface 212.

While tread elements, such as grooves, sipes, and channels, are known to aid in diverting water away from the tire tread, such elements are not as effective at diverting liquid when there is only a small amount of liquid present in a “micro-puddle.” Referring back to FIG. 1A, graph 100 illustrates an immediate degradation in tire performance when there is even a small amount of liquid present on the road surface.

FIG. 3 illustrates one embodiment of an improved tire 300 having a circumferential tread (not shown) embedded with synthetic fibers 305. The synthetic fibers 305 each have an empty cavity (not shown) configured to be filled with water or other liquids. The circumferential tread may include grooves, slots, sipes, blocks, or any other known tread elements. The tire 300 is shown on a road surface 310 that is covered with water 320. It should be understood that the road surface 310 may also be covered with oil, chemicals, or any other known liquid. As in FIGS. 2D and 2E, irregularities of the road surface 310 may cause water or other liquids to collect in puddles or “micro-puddles” as shown.

In the illustrated embodiment of FIG. 3, as a vehicle (not shown) travels over the road surface 310, the weight of the vehicle increases the pressure under the tire 300 at its footprint F. This pressure forces water into the cavities of the synthetic fibers 305, compressing the air in the cavities, allowing the cavities of the synthetic fibers 305 to fill with the water 320. More of the road surface 310 is exposed at the footprint F, and the tire 300 conforms to a greater portion of the road surface 310. Because more of the tire 300 contacts the road surface 310, greater traction is achieved and a driver is afforded better handling in wet conditions. It should be understood that, in operation, the empty cavities in the synthetic fibers may become fully or partially filled with water.

As the vehicle moves over the road surface 310, the bottom portion of the tire 300 rotates out of the footprint F and the pressure drops outside of the synthetic fibers 305. The compressed air in the empty cavity of the synthetic fibers 305 then forces the water out, and the process is repeated.

Similarly, when the tire 300 travels over a road surface covered, or partially covered, with snow or ice, the pressure from the vehicle melts the snow or ice, creating liquid. The liquid partially or fully fills the cavity in the fiber 305, then is forced out as described above.

Referring back to FIG. 1B, simplified graph 100b illustrates that the use of synthetic fibers in tires as described above improves performance in wet conditions. This improvement is shown by reference numeral 110. As graph 100 illustrates, the synthetic fibers have the greatest impact on performance in slightly wet conditions, where only “micro-puddles” are present. However, the synthetic fibers improve tire performance in all levels of wetness.

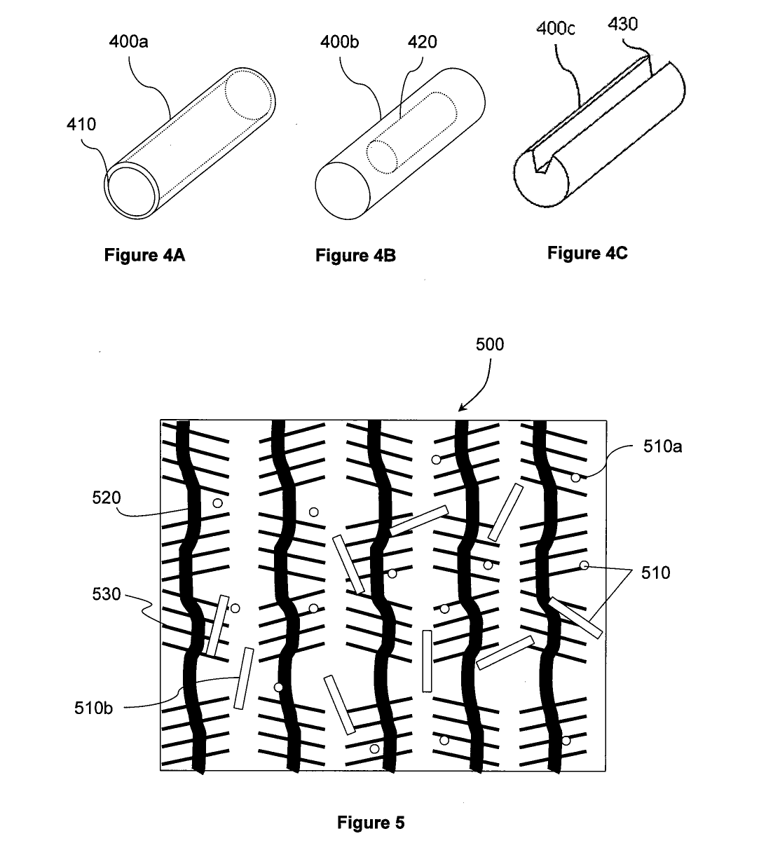

FIGS. 4A-C illustrate exemplary embodiments of synthetic fibers 400a,b,c. In the illustrated embodiments, the synthetic fibers include cavities (i.e., voids or grooves). Because air, unlike water, is compressible, the voids or grooves of the synthetic fibers fill with water when the fibers come into contact with water under pressure. When a large amount of water is present, the voids or grooves of the synthetic fibers may completely fill with water. When a small amount of water is present, the voids or grooves of the synthetic fibers may only partially fill with water.

In one embodiment, the synthetic fibers 400a,b,c have a diameter between 5 micrometers and 100 micrometers. In another embodiment, the diameter is greater than 100 micrometers. In one embodiment, the synthetic fibers are of uniform diameter. In another embodiment, the fibers vary in diameter.

In one embodiment, the synthetic fibers 400a,b,c are cut to a length of approximately 0.5 millimeters to 15 millimeters. In one embodiment, the fibers are of uniform length. In an alternative embodiment, the fibers vary in length. Any type of synthetic fiber may be used. Exemplary synthetic fibers include DUPONT® HOLLOFIL®, polyester, nylon, or any blend of synthetic fibers. In an alternative embodiment, natural fibers may be employed alone or in combination with synthetic fibers. It should be understood that different fibers have different elasticity, strength, and other characteristics. The fiber type may be selected according to these characteristics.

Referring now to the individual figures, FIG. 4A illustrates a simplified perspective view of one embodiment of a synthetic fiber 400a. In this embodiment, the synthetic fiber 400a has a void 410 that extends along the length of the fiber. The void 410 may be created by extruding the synthetic fiber 400a. Alternatively, the void may be created by injecting gas in the fiber, or by other known manual or mechanical processes. In the illustrated embodiment, the void 410 has a generally circular cross-section. In alternative embodiments (not shown), the void may have a polygonal cross-section or an irregular cross-section defined by one or more curved or straight lines.

In the illustrated embodiment, the synthetic fiber 400a has a single void 410. Additionally, the void 410 is approximately coaxial with the longitudinal axis of the synthetic fiber 400a. In alternative embodiments (not shown), the void and the synthetic fiber do not share the same axis. Further, in additional alternative embodiments, the synthetic fiber includes a plurality of voids.

FIG. 4B illustrates a simplified perspective view of an alternative embodiment of a synthetic fiber 400b. In this embodiment, the synthetic fiber 400b includes a void 420 that is completely enclosed. The void 420 may be created by extruding a long synthetic fiber, thereby creating an elongated void. Alternatively, the void may be created by injecting gas in the fiber, or by other known manual or mechanical processes. In one embodiment, the void 420 becomes enclosed within the length of fiber by cutting the long fiber into small lengths with a hot knife or other cutting device. The heat from the cutting device seals the ends of the small lengths of fiber as shown. In the illustrated embodiment, the void 420 has a generally circular cross-section. In alternative embodiments (not shown), the void may have a polygonal cross-section or an irregular cross-section defined by one or more curved or straight lines.

In the illustrated embodiment, the synthetic fiber 400b has a single void 420. Additionally, the void 420 is approximately coaxial with the synthetic fiber 400b. In alternative embodiments (not shown), the void and the synthetic fiber do not share the same axis. Further, in additional alternative embodiments, the synthetic fiber includes a plurality of voids. In one such embodiment, the plurality of voids includes at least one void that extends along the entire length of the fiber and at least one void that is completely enclosed.

FIG. 4C illustrates a simplified perspective view of an additional alternative embodiment of a synthetic fiber 400c. In this embodiment, the synthetic fiber 400c includes a groove 430 that that extends along the entire length of the synthetic fiber 400c. In an alternative embodiment (not shown), the groove extends along only a portion of the synthetic fiber. The groove 430 may be created by extruding the synthetic fiber 400c or it may be imparted on the synthetic fiber by injecting gas or using other known mechanical or manual means.

In the illustrated embodiment, the groove 430 has a polygonal cross-section. In alternative embodiments (not shown), the groove may have a curved cross-section or an irregular cross-section defined by one or more curved or straight lines.

In the illustrated embodiment, the synthetic fiber 400c has a single groove 430. In an alternative embodiment (not shown), the synthetic fiber includes a plurality of grooves. In other alternative embodiments, the synthetic fiber includes one or more grooves and one or more voids. The one or more voids may include one or more voids that extend along the entire length of the fiber and/or one or more voids that are completely enclosed.

FIG. 5 illustrates a simplified top view of one embodiment of a tire tread 500 having a plurality of embedded synthetic fibers 510. In the illustrated embodiment, the tire tread includes a plurality of grooves 520 and sipes 530. In alternative embodiments (not shown), the tire tread may include ribs, slots, recesses, and blocks of various patterns.

In the illustrated embodiment, the plurality of synthetic fibers 510 are randomly dispersed and randomly aligned. In other words, no attempt is made to provide a uniform alignment. As shown in the illustrated embodiment, at least one of the plurality of synthetic fibers 510 is exposed to the surface of the tire tread 500. In other words, at least a portion of one of the plurality of synthetic fibers 510 is not covered by the rubber of the tire tread 500. In one embodiment, additional synthetic fibers (not shown) are completely embedded in the tire tread 500, and as the tire tread 500 wears over time, these additional synthetic fibers become exposed to the surface of the tire tread 500. In an alternative embodiment (not shown), all of the synthetic fibers are completely embedded in the tire tread and become exposed to the surface as the tire tread wears. In another alternative embodiment (not shown), all of the synthetic fibers are exposed to the surface of the tire tread.

With continued reference to the embodiment of FIG. 5, at least one of the fibers 510a is oriented such that an end of the fiber is exposed to a surface of the tire tread 500. It should be understood that for an end of a fiber to be exposed, the fiber may be oriented generally radially, or at an angle with respect to a radial line.

Further, in the embodiment of FIG. 5, at least one of the fibers 510b is oriented generally circumferentially, such that the length of the fiber is exposed to a surface of the tire tread 500. In the illustrated embodiment, at least one of the fibers 510 is exposed to at least one surface that defines a sipe 530. In other words, a portion of at least one of the fibers 510 is not covered by the rubber of the tire tread 500 and is adjacent the void defined by the sipe of the tire.

Additionally, FIG. 5 shows at least one of the fibers 510 exposed to at least one surface that defines a groove 520. Sipes and grooves aid in directing water away from a road surface. Thus, if a fiber 510 is exposed to a groove 520 or a sipe 530, when the tire travels over a wet surface, water enters the groove 520 or sipe 530 and fills the void of the synthetic fiber 510, as shown in FIG. 3.

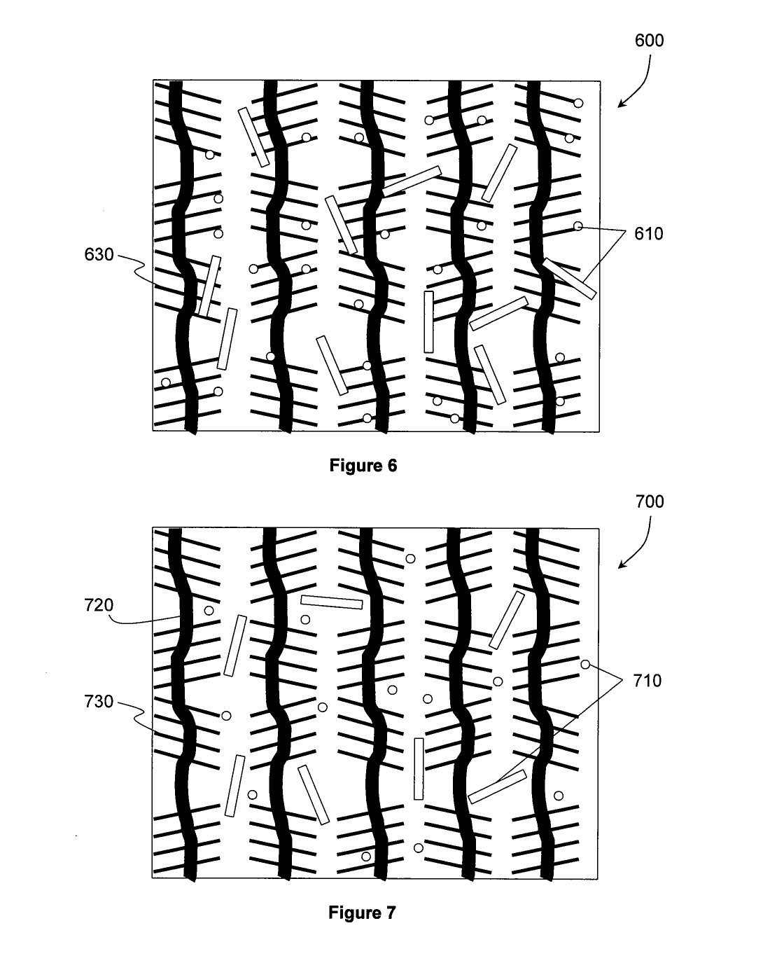

In an alternative embodiment, illustrated in FIG. 6, a tire tread 600 has a plurality of embedded synthetic fibers 610, wherein every fiber is exposed to a surface that defines a sipe 630. In another alternative embodiment (not shown), every fiber is exposed to a surface that defines a groove.

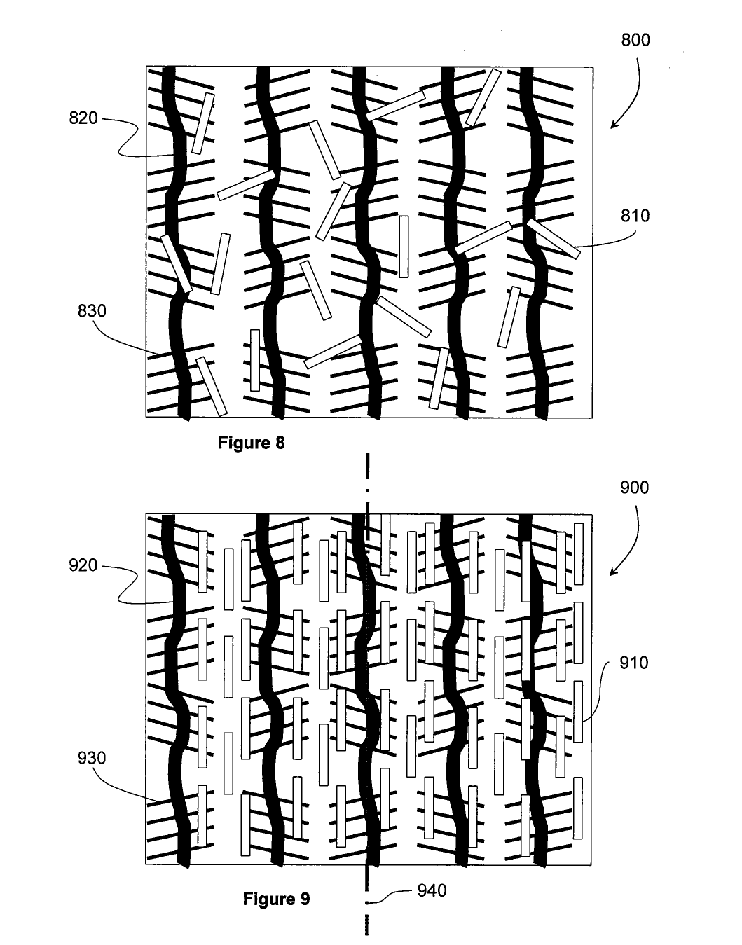

In another embodiment, illustrated in FIG. 7, a tire tread 700 has a plurality of embedded synthetic fibers 710, wherein none of the fibers 710 are exposed to grooves 720 or sipes 730. In this embodiment, although the tire tread 700 would not direct water towards the synthetic fibers 710, the fibers 710 would still come into contact with water as the tire traveled through puddles or micro-puddles. Thus, the synthetic fibers 700 would still fill with water from a road surface, as shown in FIG. 3.

FIG. 8 illustrates a simplified top view of an alternative embodiment of a tire tread 800 having a plurality of embedded synthetic fibers 810 and a plurality of groove 820 and sipes 830. In the illustrated embodiment, all of the plurality of embedded synthetic fibers 810 are generally orthogonal to a radius of the tire. In other words, the lengths, rather than the ends, of the fibers 810 are exposed to the surface of the tire tread 800. Although the fibers 810 are generally orthogonal to a radius of the tire, the direction of each fiber 810 is random.

In the illustrated embodiment, an end of at least one of the fibers 810 is exposed to a surface that defines a sipe 830. In an alternative embodiment (not shown), every fiber is exposed to a surface that defines a sipe. In another alternative embodiment, none of the fibers are exposed to sipes.

FIG. 9 illustrates a simplified top view of an alternative embodiment of a tire tread 900 having a plurality of aligned synthetic fibers 910 and a plurality of groove 920 and sipes 930. In the illustrated embodiment, all of the plurality of embedded synthetic fibers 910 are generally circumferentially aligned and parallel to an equatorial plane of the tire. In an alternative embodiment (not shown), each fiber 910 is generally circumferentially aligned and laterally oriented. In other words, each fiber is oriented substantially perpendicular to an equatorial plane 940 of the tire. In another alternative embodiment (not shown), each fiber 910 is generally circumferentially aligned and oriented at an acute angle with respect to an equatorial plane 940 of the tire, with each fiber 910 having the same angle. In yet another alternative embodiment (not shown), each fiber 910 is generally circumferentially aligned and oriented at an obtuse angle with respect to an equatorial plane 940 of the tire, with each fiber 910 having the same angle.

In the illustrated embodiment, an end of at least one of the fibers 910 is exposed to a surface that defines a groove 920 or a sipe 930. In an alternative embodiment (not shown), every fiber is exposed to a surface that defines a sipe. In another alternative embodiment (not shown), none of the fibers are exposed to sipes.

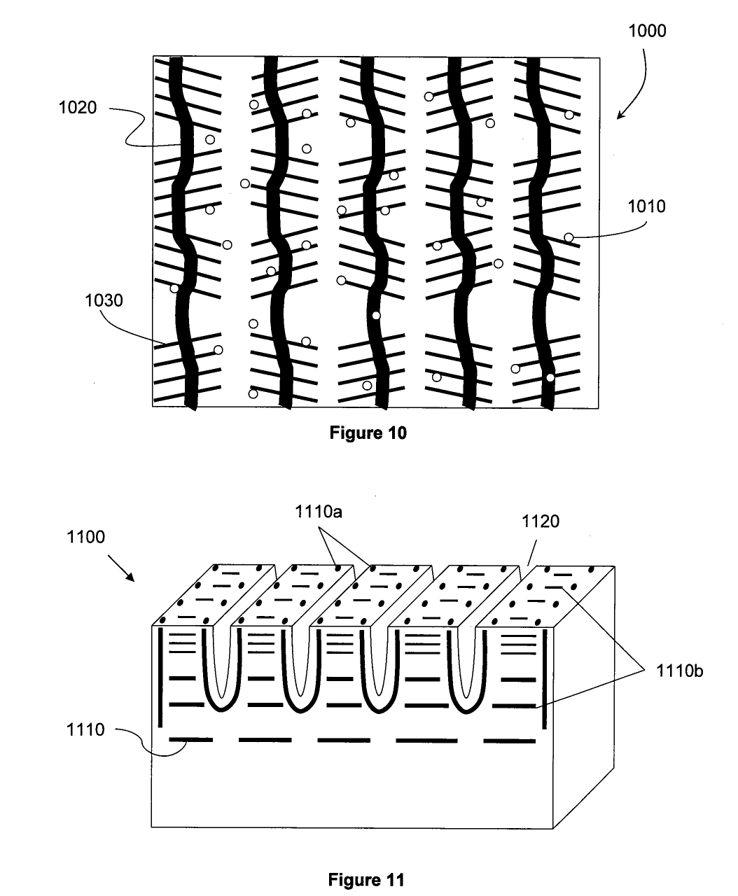

FIG. 10 illustrates a simplified top view of an alternative embodiment of a tire tread 1000 having a plurality of embedded synthetic fibers 1010 and a plurality of grooves 1020 and sipes 1030. In the illustrated embodiment, the plurality of embedded synthetic fibers 1010 are all aligned such that the ends, rather than the lengths, of the fibers 1010 are exposed to the surface of the tire tread 1000. It should be understood that for an end of a fiber to be exposed, the fiber may be oriented generally radially, or at an angle with respect to a radial line.

In the illustrated embodiment, an end of at least one of the fibers 1010 is exposed to a surface that defines a groove 1020 or a sipe 1030. In an alternative embodiment (not shown), every fiber is exposed to a surface that defines a sipe. In another alternative embodiment (not shown), none of the fibers are exposed to sipes. In an additional alternative embodiment (not shown), every fiber is exposed to a surface that defines a groove. In yet another alternative embodiment (not shown), none of the fibers are exposed to grooves.

In addition to selecting the orientation of the fibers, the length, diameter, and elasticity of the fibers may be selected to improve tire performance. Additionally, the density of the fibers within the tread may also be selected to improve tire performance. For example, FIG. 11 illustrates a perspective view of a section of one embodiment of a tire tread 1100 having fibers 1110. In the illustrated embodiment, sipes 1120 are also shown. The tire tread may also have grooves, ribs, slots, recesses, and blocks of various patterns.

In the illustrated embodiment, the fibers 1110 include fibers 1110a that are aligned substantially radially near the sipes 1120 and fibers 1110b that are aligned laterally at locations away from sipes 1120. Additionally, the fibers are distributed at a higher density near the surface of the new tire, and at a relatively lower density further away from the surface. Further, in the illustrated embodiment, fibers with a smaller diameter are placed near the surface and fibers with a larger diameter are placed away from the surface. Additionally, fibers with a shorter length are placed near the surface and fibers with a longer length are placed away from the surface.

In one embodiment, fibers near the surface are constructed of a different material than fibers away from the surface. For example, in one embodiment, the fibers near the surface are constructed of nylon and fibers away from the surface are constructed of polyester. In an alternative embodiment, fibers near the surface are constructed of polyester and fibers away from the surface are constructed of nylon. In another alternative embodiment, other materials may be selected.

In alternative embodiments (not shown), fibers are distributed at a lower density near the surface of the new tire, and at a relatively higher density further away from the surface. In another alternative embodiment (not shown), fibers with a larger diameter are placed near the surface and fibers with a smaller diameter are placed away from the surface. In yet another alternative embodiment (not shown), fibers with a longer length are placed near the surface and fibers with a shorter length are placed away from the surface.

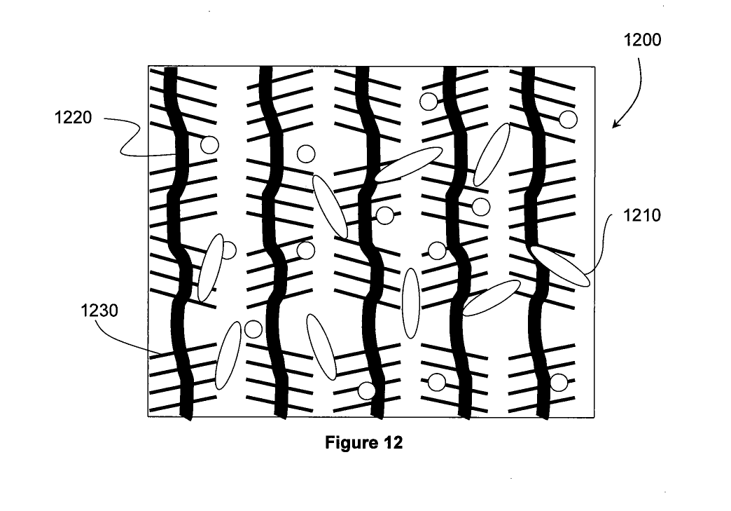

FIG. 12 illustrates a simplified top view of one embodiment of a tire tread 1200 having a plurality of embedded synthetic fibers 1210 and a plurality of grooves 1220 and sipes 1230. FIG. 12 illustrates the same embodiment shown in FIG. 5, after the tire has been used and the tread has become worn.

As is understood by one of ordinary skill in the art, a tire tread wears with use over time. As a tire tread wears, the surface area decreases in any grooves, sipes, ribs, slots, recesses, and blocks. As a result, the performance of the tire changes in dry, wet, and snowy conditions. As shown in FIG. 12, however, when synthetic fibers 1210 are embedded in a tire tread 1200, as the tread wears down, more of the synthetic fibers 1210 are exposed to the surface. Exposing more of the synthetic fibers 1210 promotes performance of the tire even as the tread begins to wear dependant on the density of fibers in the compound.

In one embodiment, illustrated in FIG. 12, the synthetic fibers 1210 are flattened by the pressure caused by the weight of the vehicle. In an alternative embodiment (not shown), the fibers are of sufficient strength such that they maintain their shape. In such an embodiment, the fibers 1210 simply wear away at the same rate at which the tire tread 1200 wears.

In one embodiment, each fiber 1210 remains fixed within the tread 1200 until the fiber completely wears away. In an alternative embodiment, as the tire tread 1200 wears, the synthetic fibers 1210 will fall out of the tire tread 1200.

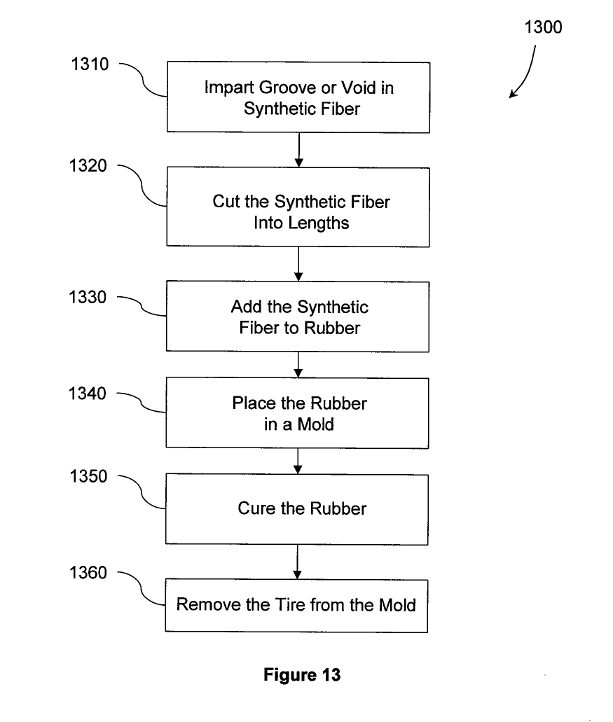

FIG. 13 illustrates a process 1300 for making a tire having embedded synthetic fibers. In one embodiment, the process 1300 may be performed using existing tire making equipment that is known in the art.

To embed synthetic fibers in a tire tread, the at least one void or groove is imparted in a synthetic fiber (step 1310). The void or groove may be created via extrusion. In one embodiment, an extrusion process creates an air pocket along the center of the fiber. In one embodiment, the fiber has a outer diameter between 5 micrometers and more than 100 micrometers. In an alternative embodiment, an extrusion process creates a plurality of air pockets and grooves. In another alternative embodiment, grooves are imparted on the fiber by the injection of gas or by other known mechanical or manual means.

The fiber is then cut (step 1320). In one embodiment, the fiber is cut into pieces that are approximately 0.5 to 10 millimeters in length. In one embodiment, all of the fiber pieces are the same length. In an alternative embodiment, the fiber pieces vary in length.

After the fiber is cut, the lengths of fiber are added to green rubber (step 1330). In one embodiment, the fibers are added while the rubber is mixed by a mixer such as a banbury mixer, roller, or the like. In an alternative embodiment, the fibers are added while the rubber is being extruded from a mixer. After the fibers are added to the rubber, the rubber is placed in a mold (step 1340). In an alternative embodiment, the fibers are added after the rubber is placed in a mold. After the lengths of fiber are added to the green rubber, the rubber is cured in the mold (step 1350). The tire is then removed from the mold (step 1360).

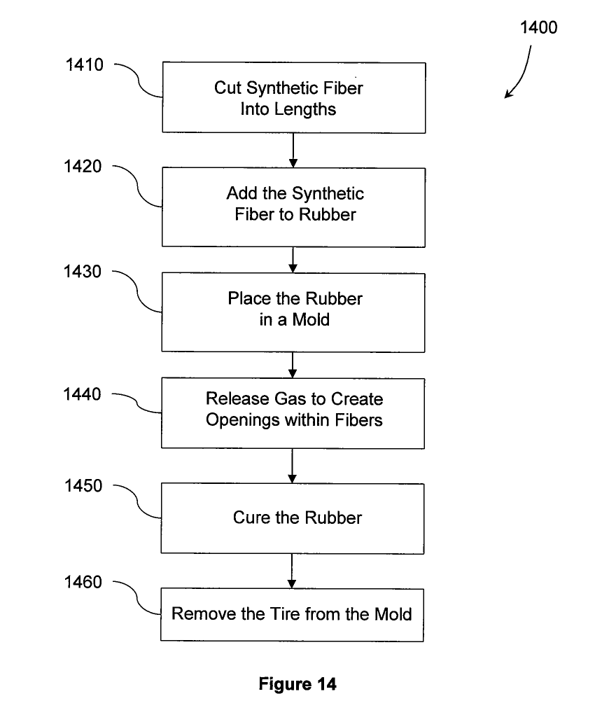

FIG. 14 illustrates an alternative embodiment 1400 for making a tire having embedded synthetic fibers. In this embodiment, at the initial step (step 1410) the fiber is cut. In one embodiment, the fiber is cut into pieces that are approximately 0.5 to 10 millimeters in length. In one embodiment, all of the fiber pieces are the same length. In an alternative embodiment, the fiber pieces vary in length.

After the fiber is cut, the lengths of fiber are added to green rubber (step 1420). In one embodiment, the fibers are added while the rubber is mixed by a mixer such as a banbury mixer, roller, or the like. In an alternative embodiment, the fibers are added while the rubber is being extruded from a mixer. In another alternative embodiment, the fibers are added after the rubber is placed in a mold.

After the fiber is added to the rubber, the rubber is placed in a mold (step 1430) and gas is released (step 1440). The gas penetrates the small lengths of fibers, thereby creating openings within the fibers. In other words, gas is injected in the fibers. In an alternative embodiment, grooves or voids are initially imparted in the synthetic fiber, as in FIG. 13, and gas is injected in the fibers at a later stage to ensure that cavity is still present within the fiber.

The rubber is then cured in the mold (step 1450). In alternative embodiments (not shown), gas is released during the curing process or after the curing process. Finally, the tire is removed from the mold (step 1460).

In other alternative embodiments (not shown), the tire making process includes additional steps to provide a specified orientation of the fibers such as shown in FIGS. 8-11. In one such embodiment, after the fibers are added to the green rubber, the green rubber is extruded or rolled. The rollers or extruders apply forces on the rubber that causes the fibers to align in the direction in which the rubber is travelling. The green rubber is then wound around a carcass such that the fibers are oriented in a circumferential direction. The carcass is then placed in a vulcanization mold having a plurality of thin plates configured to impart sipes in the green rubber. When the thin plates are pressed into the green rubber, the fibers that contact the plates are forced into a radial orientation. A more detailed explanation of this process is provided in U.S. Pat. No. 6,374,885, incorporated herein by reference.

While the present application illustrates various embodiments, and while these embodiments have been described in some detail, it is not the intention of the applicant to restrict or in any way limit the scope of the claimed invention to such detail. Additional advantages and modifications will readily appear to those skilled in the art. Therefore, the application, in its broader aspects, is not limited to the specific details, the representative apparatus, and illustrative examples shown and described. Accordingly, departures may be made from such details without departing from the spirit or scope of the applicant's claimed invention.

1. A tire having a circumferential tread, the tire comprising:
a plurality of synthetic fibers embedded in the circumferential tread such that a portion of at least one of the plurality of synthetic fibers is exposed to a surface of the circumferential tread, wherein the plurality of synthetic fibers have cavities configured to be at least partially filled with water or other liquid.

2. The tire of claim 1, wherein the plurality of synthetic fibers are randomly aligned in the circumferential tread.

3. The tire of claim 1, wherein one or more of the plurality of synthetic fibers are substantially radially oriented.

4. The tire of claim 1, wherein one or more of the plurality of synthetic fibers are substantially orthogonal to a radius of the tire.

5. The tire of claim 1, wherein the synthetic fibers are further configured to discharge the water or other liquid when a portion of the circumferential tread containing the synthetic fibers moves out of contact with a wet or damp surface.

6. The tire of claim 1, wherein the circumferential tread includes a plurality of sipes provided therein, wherein an end of at least one of the synthetic fibers is exposed to a tread surface that defines a sipe.

7. The tire of claim 1, wherein the synthetic fibers are extruded synthetic fibers.

8. The tire of claim 1, wherein each of the plurality of synthetic fibers has a length of about 0.5 millimeters to about 10 millimeters.

9. The tire of claim 1, wherein each of the plurality of synthetic fibers has a diameter of about 5 micrometers to about 100 micrometers.

10. A circumferential tread of a tire, the tread comprising:
a plurality of hollow synthetic fibers configured to at least partially fill with a liquid when a portion of the circumferential tread containing the hollow synthetic fibers contacts a wet or damp surface, wherein the hollow synthetic fibers are further configured to discharge the liquid when the portion of the circumferential tread containing the hollow synthetic fibers moves out of contact with the wet or damp surface.

11. The tread of claim 10, wherein the plurality of hollow synthetic fibers are oriented substantially radially.

12. The tread of claim 10, wherein the plurality of hollow synthetic fibers are oriented randomly.

13. The tread of claim 10, wherein the tread includes a plurality of grooves and sipes.

14. The tread of claim 13, wherein a portion of at least one of the plurality of hollow synthetic fibers is exposed to an outer surface of at least one of the plurality of grooves and sipes.

15. The tread of claim 10, wherein each of the plurality of hollow synthetic fibers has a length between about 0.5 millimeters and about 10 millimeters.

16. A method of molding a tire having a plurality of synthetic fibers, the method comprising the steps of:
adding lengths of synthetic fibers to green rubber, wherein each fiber has at least one cavity;
placing the green rubber in a mold, the mold having internal cavity-defining surfaces; and
curing the green tire within the mold.

17. The method of claim 16, further comprising a step of orienting at least one of the lengths of fiber in a radial direction with respect to the tire mold.

18. The method of claim 16, further comprising a step of imparting the at least one cavity in each synthetic fiber.

19. The method of claim 18, wherein the step of imparting at least one cavity in each synthetic fiber includes a step of extruding the fiber.

20. The method of claim 18, wherein the step of imparting at least one cavity in each synthetic fiber includes a step of injecting gas in the fiber.
